(19) United States
(12) Patent Application Publication
(10) Pub. No.: US 2024/0371284 A1
(43) Pub. Date: Nov. 7, 2024

(54) METHOD AND APPARATUS FOR ZONE STRATEGY SELECTION

(71) Applicant: Strategic Coach, Toronto (CA)

(72) Inventors: Barbara Sue Smith, Toronto (CA); Daniel J. Sullivan, Toronto (CA)

(73) Assignee: Strategic Coach, Toronto (CA)

(21) Appl. No.: 18/142,723

(22) Filed: May 3, 2023

(51) Int. Cl. G09B 5/02; G06N 20/00

(52) U.S. Cl. CPC G09B 5/02; G06N 20/00

(57) ABSTRACT

An apparatus for zone strategy selection comprising a memory communicatively connected to a processor containing instructions to receive user data comprising at least a user goal, generate zone strategies based on the user data, receive a plurality of zone strategy scores as a function of the zone strategies, wherein at least one zone strategy score of the plurality of zone strategy scores is associated to at least one individual zone strategy of the zone strategies, determine follow through data as a function of the plurality of zone strategy scores and the zone strategies, and create and transmit a user interface data structure (UIDS) to a graphical user interface (GUI) comprising the zone strategies and the follow through data, the GUI configured to display the zone strategies and the follow through data as a function of the UIDS.

### FIELD OF THE INVENTION

The present invention generally relates to the field of artificial intelligence. In particular, the present invention is directed to a method and an apparatus for zone strategy selection.

### BACKGROUND

In general, systems and apparatus used for zone strategy selection suffer from inability to account for and process the large and poorly defined data provided therefore. Undesirable or inaccurate zone strategy selection techniques can cause short term and long-term consequences.

### SUMMARY OF THE DISCLOSURE

In an aspect, an apparatus for zone strategy selection is described. Apparatus includes at least a processor and a memory communicatively connected to the processor. The memory containing instructions configuring the processor to receive user data, wherein the user data comprises at least a user goal, generate zone strategies based on the user data, receive a plurality of zone strategy scores as a function of the zone strategies wherein at least one zone strategy score of the plurality of zone strategy scores is associated to at least one individual zone strategy of the zone strategies, determine follow through data as a function of the plurality of zone strategy scores and the zone strategies, create a user interface data structure, wherein the user interface data structure comprises the zone strategies and the follow through data and transmit the user interface data structure. Apparatus further includes a graphical user interface (GUI) communicatively connected to the at least a processor, the GUI configured to receive the user interface data structure and display the zone strategies and the follow through data as a function of the user interface data structure.

In another aspect, a method for zone strategy selection is described. The method includes receiving, by at least a processor, user data, wherein the user data comprises at least a user goal, generating, by the at least a processor, zone strategies based on the user data, receiving, by the at least a processor, a plurality of zone strategy scores as a function of the zone strategies wherein at least one zone strategy score of the plurality of zone strategy scores is associated to at least one individual zone strategy of the zone strategies, determining, by the at least a processor, follow through data as a function of the plurality of zone strategy scores and the zone strategies, creating, by the at least a processor, a user interface data structure, wherein the user interface data structure comprises the zone strategies and the follow through data and transmitting, by the at least a processor, the follow through data, the zone strategies, and the user interface data structure to a graphical user interface (GUI) communicatively connected to the at least a processor. The GUI is configured to receive the user interface data structure and display the zone strategies and the follow through data as a function of the user interface data structure.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for zone strategy selection;

FIG. 2 is an exemplary embodiment of a graphical user interface in accordance with the subject disclosure;

FIG. 3 is a block diagram of exemplary embodiment of a machine learning module;

FIG. 4 is a diagram of an exemplary embodiment of a neural network;

FIG. 5 is a block diagram of an exemplary embodiment of a node;

FIG. 6 is a graph illustrating an exemplary relationship between fuzzy sets;

FIG. 7 is a block diagram of a chatbot system;

FIG. 8 is a flow diagram illustrating an exemplary embodiment of a method for zone strategy selection; and

FIG. 9 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses and methods for zone strategy selection. In an embodiment, methods may include utilizing machine learning to generate follow through data containing instructions on improving a particular zone strategy.

Aspects of the present disclosure can be used to generate zone strategies using classifiers and/or machine learning models. Exemplary embodiments illustrating aspects of the present disclosure are described below in the context of several specific examples.

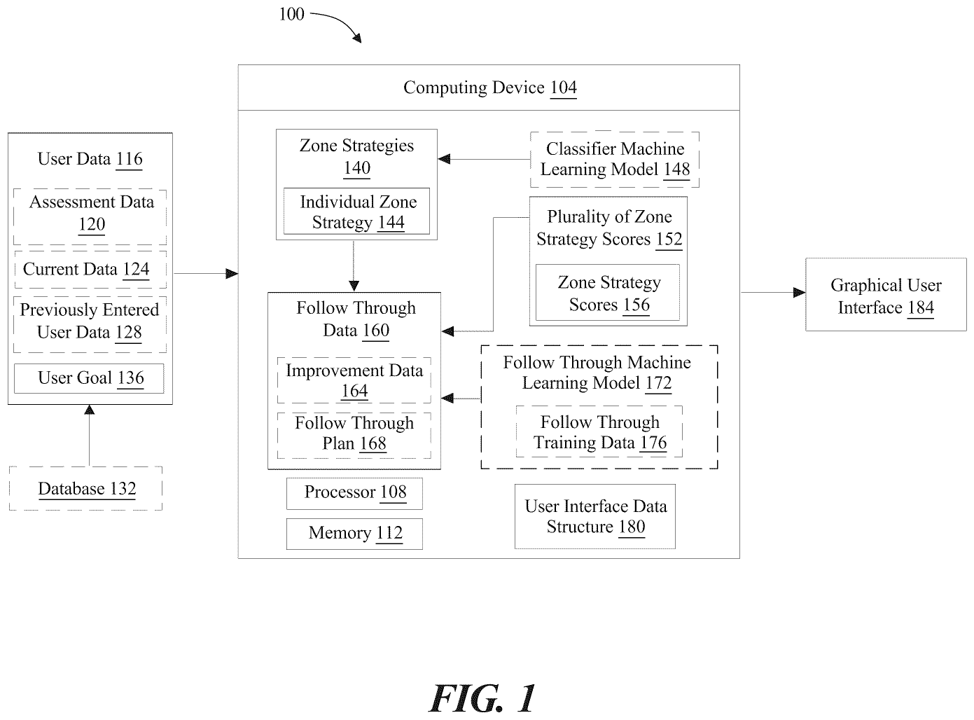

Referring now to FIG. 1, an exemplary embodiment of an apparatus 100 for zone strategy selection is illustrated. Apparatus 100 includes a computing device. Apparatus 100 includes a processor. Processor 108 may include, without limitation, any processor 108 described in this disclosure. Processor 108 may be included in a computing device. Computing device 104 may include any computing device 104 as described in this disclosure, including without limitation a microcontroller, microprocessor, digital signal Processor (DSP) and/or system on a chip (SoC) as described in this disclosure. Computing device 104 may include, be included in, and/or communicate with a mobile device such as a mobile telephone or smartphone. Computing device 104 may include a single computing device operating independently or may include two or more computing devices operating in concert, in parallel, sequentially or the like; two or more computing devices may be included together in a single computing device 104 or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 104 may include but is not limited to, for example, a computing device 104 or cluster of computing devices in a first location and a second computing device 104 or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device, which may operate in parallel, in series, redundantly, or in any other manner used for distribution of tasks or memory 112 between computing devices. Computing device 104 may be implemented, as a non-limiting example, using a “shared nothing” architecture.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 may perform determinations, classification, and/or analysis steps, methods, processes, or the like as described in this disclosure using machine-learning processes. A “machine-learning process,” as used in this disclosure, is a process that automatedly uses a body of data known as “training data” and/or a “training set” (described further below in this disclosure) to generate an algorithm that will be performed by a Processor 108 module to produce outputs given data provided as inputs; this is in contrast to a non-machine learning software program where the commands to be executed are determined in advance by a user and written in a programming language. A machine-learning process may utilize supervised, unsupervised, lazy-learning processes and/or neural networks, described further below.

With continued reference to FIG. 1, apparatus 100 includes a memory 112 communicatively connected to processor 108. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, using a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, apparatus 100 may receive user data 116. As used in this disclosure, “user data” is data associated with a user of interest. In some embodiments, user data 116 may include any data associated with a specific user. A user may be a user, or a company associated with a user. User data 116 may include, for example, a user personal attributes, a user's confidence levels, a user's data describing a user's schedule, a user's work or personal calendar, a user's commitments, a user's job role or title, clubs or associations that a user belongs to, family connections and related commitments (such as childcare, elder care, pets, etc.) and the like.

With continued reference to FIG. 1, user data 116 may include any data relating a user's confidence levels. This may include any indication that may determine a user's confidence and/or a lack thereof. For example, user data 116 may include a user's stamina with regards to a particular activity wherein the user's stamina may be used to determine a user's confidence. Continuing, a low stamina may indicate low confidence or a lack thereof in a particular activity. “Confidence” as described in this disclosure is a feeling of self-assurance arising from one's appreciation of one's own abilities. Low confidence may indicate that a user has a low appreciation of their own abilities or a lack of self-assurance as a result of one's abilities. User data 116 may include data relating to a user's confidence levels in social interactions (e.g. failure to make eye contact, stuttering while speaking, nervousness during a public speech, failure to maintain proper body posture, avoiding social situations altogether, manifesting physical signs of stress or anxiety during a social interaction, and the like). User data 116 may further include data relating to a user's confidence in work related situations (e.g. avoidance of complex tasks, failure to be assertive or lacking assertiveness, fear of taking on new projects, fear of taking on new responsibilities, failure to complete tasks, failure to start tasks, avoidance of difficult work, lacking confidence to peak to an employer or an employee, and the like). User data 116 may further include data relating to a user's confidence in relation to self-image (e.g. body image issues, lack of confidence in knowledge of a particular field, poor stress management, lack of self-growth, and the like. User data 116 may further include any data that may indicate a lack of confidence in any particular field. This includes but is not limited to, poor work product, failure to engage in social interactions, failure to take responsibility, poor negotiating skills, poor management skills and the like. Additionally or alternatively, user data 116 may include data relating a user's abilities. Data relating to a user's abilities may be used to increase a user's confidence by increasing a user's experience in a specific ability. Data relating to a user's abilities may include a user's ability to interact with one another, a user's ability to write or communicate effectively, a user's knowledge or ability to perform functions in a particular field such as math, science, finance, and the like.

With continued reference to FIG. 1, user data 116 may include basic information, such as and without limitations, age, gender, marital and/or family status, previous work history, previous education history, and the like. In some embodiments, user data 116 may be received through an input device. In some instances, input device may be apparatus 100. In some instances, input device may include a remote device. In instances where user data 116 is input into a remote input device, remote device may transmit user data 116 across a wireless connection. In some embodiments, wireless connection may be any suitable connection (e.g., radio, cellular). In some instances, input device may include a computer, laptop, smart phone, tablet, or things of the like. In some instances, user data 116 may be stored in a data store and associated with a user account. It should be noted that data store may be accessed by any input device, using authorization credentials associated with user data 116. In some instances, user data 116 may be created and stored via a laptop and accessed from tablet, using authorization credentials.

With continued reference to FIG. 1, user data 116 may further include assessment data 120 wherein assessment data 120 includes physiological traits of a user. “Assessment data” as for the purposes of this disclosure is any data that may be used to evaluate a particular trait of a user. For example assessment data 120 may include a user's spending habits, educational level, marital status and the like. Assessment data 120 may further include physiological traits of a user. “Physiological traits” for the purposes of this disclosure are biological traits relating to a human such as a user's height, weight, fitness, blood pressure, oxygen levels, age, body temperature and the like. Physiological traits may be received from an input device, such as computing device, or a device capable of measuring psychological traits such as a wrist-based heart monitor, a wrist-based oxygen monitor and the like. Wearable devices such as wrist-based heart monitors, wrist-based oxygen monitors, wearable EKG monitors and the like may be used to receive a plurality of physiological related data. This may include a user's heart rate over a given period of time, a user's sleep patterns, a user's oxygen levels and the like. Wearable devices may include remote devices that may communicate with computing system either over a wired or wireless connection. Wearable devices may include, as non-limiting examples, smartwatches, fitness trackers, smart glasses, smart gloves, and the like. In an embodiment, physiological data may be used to determine a user's confidence level by monitoring changes in the physiological data during an activity. For example, an increase in heart rate during a social interaction, may indicate that a user is not comfortable or confident in the interaction.

With continued reference to FIG. 1, user data 116 may further include current data 124. “Current data” for the purposes of this disclosure is data relating to a user at the current moment or during the current iteration of a computing process. Current data 124 may include any data that has not yet been entered yet. Current data 124 may further include any data in which a user may seek to receive outputted results from computing device 104 as described further below. User data 116 may further include a plurality of previously entered user data 128. “Previously entered user data” as described in this disclosure is any user data 116 that corresponds to a time or iteration before current data. Previously entered user data 128 may be user data 116 relating to a user of a previous iteration of computing device. Previously entered user data 128 may further be any user data 116 received by computing device 104 on a previous event. In some cases, computing device 104 may input current data 124 into previously entered user data 128 at the completion of the computing process to be used for later on. In some cases, plurality of previously entered user data 128 includes a plurality of current data 124 taken from previous iterations. Previously entered user data 128 may be retrieved from a storage associated with computing device 104 or a database 132 as described in this disclosure. In some cases, previously entered user data 128 may associated with a user account, wherein the user account is a label indicating that previously entered user data 128 belongs or is associated with a specific user.

Still referring to FIG. 1, database 132 may be implemented, without limitation, as a relational database, a key-value retrieval database such as a NOSQL database, or any other format or structure for use as a database that a person skilled in the art would recognize as suitable upon review of the entirety of this disclosure. Database 132 may alternatively or additionally be implemented using a distributed data storage protocol and/or data structure, such as a distributed hash table or the like. Database 132 may include a plurality of data entries and/or records as described above. Data entries in database 132 may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database 132 may store, retrieve, organize, and/or reflect data and/or records.

With continued reference to FIG. 1, user data 116 includes at least a user goal 136. “User goal” for the purposes of this disclosure is an objective or a desired result that a user seeks to benefit from. At least a user goal 136 may include a plurality of user goals. User goal 136 may include the objective of finishing tasks on time, improving self-confidence, improving confidence related to social interactions, improving the assertiveness of a user and the like. User goal 136 may further include any improvement of any attributes of a user as described in user data 116 above. This includes but it not limited to improvement of various physiological traits, improvement in finances, improvement in employment and the like.

With continued reference to FIG. 1, user data 116 may include data in the form of audio, text, images, audio-visual data, and the like. In some cases, user data 116 may include a user's search history from computing device 104, internet browser or website. In some cases, user data 116 may include financial documents, such as previous spending history, credit card transactions and the like. In some cases, user data 116 may include screenshots of conversations, actions or activities that were taken on a computing device. In some cases, user data 116 may include data captured from virtual environments. Virtual environment may include a plurality of devices connected through networks. In a non-limiting example, apparatus 100 may be configured to receive user data 116 from the internet. Such user data 116 may include data from social media posts, feeds, browsing histories, and the like thereof. Apparatus 100 may utilize a web crawler to collect user data 116 in the virtual environment. Apparatus 100 may be configured to extract an action pattern, wherein the action pattern refers to a set of behaviors or actions taken by a user when interacting with apparatus 100.

With continued reference to FIG. 1, receiving user data 116 may further include processing user data 116. “Processing” for the purposes of this disclosure refers to the conversion, maintenance, or modification of data such that the data may be properly used by a computing device. For example, processing user data 116 may include compression by inter-frame coding as described in this disclosure. Processing user data 116 may further include converting user data 116 into text-based data. Computing device 104 may use “speech to text” or “Automatic speech recognition” in order to convert audio data inputted by a user into text data that may be used later on by computing device. “Automatic speech recognition (ASR)” also known as “speech recognition” or “speech to text “is a computer algorithm that may receive an input of audio data, wherein the audio data May include any recognizable sounds and convert those sounds into text-based data. For example, a computing device 104 may output text data indicating that a car horn was heard in the audio-visual data. In another non limiting example, a computing device 104 may output speech related to a conversation that was recorded within the audio-visual data. A computing device, such as the one mentioned herein may receive audio or audio-visual data, beak down the audio data into a plurality of phonemes, determine a sequence of the phonemes, compare the sequence to a plurality of sequence, and output a text based on the comparison of the plurality of sequences. ASR algorithms may use a plurality of algorithms to convert speech to text. This may include, but is not limited to hidden Markov models, dynamic time warping based speech recognition, neural networks, machine learning algorithms any other algorithms that may convert text to speech. In some cases, receiving user data 116 may include transmitting user data 116 to an ASR device, wherein the ASR device is a device configured to convert audio data to speech. In some cases, the ASR device is communicatively connected to computing device. In some cases, the ASR device is wired or wirelessly connected to computing device. In some cases, computing device 104 includes ASR device. In some cases, ASR device may be connected to a network, wherein computing device 104 may transmit user data 116 to the network for processing. In some cases, ASR device is a preprogrammed device capable of speech to text recognition. In some cases, computing device 104 may implement already existing speech to text software or algorithms. Additionally, or alternatively, receiving user data 116 may include receiving text data from an ASR device. User data 116 may further be received using a data crawler or a data scraper, wherein the data crawler is configured to search the internet, computing device 104 or any other device for data relating to a user. Data crawler may be used to extract data from a user's social medial profile and the like.

With continued reference to FIG. 1, receiving user data 116 may further include processing user data 116 using an image classifier. An “image classifier,” as used in this disclosure is a machine-learning model, such as a mathematical model, neural net, or program generated by a machine-learning algorithm known as a “classification algorithm,” as described in further detail below, that sorts inputs of image information into categories or bins of data, outputting the categories or bins of data and/or labels associated therewith. Image classifier may be configured to output at least a datum that labels or otherwise identifies a set of images that are clustered together, found to be close under a distance metric as described below, or the like. Computing device 104 and/or another device may generate image classifier using a classification algorithm, defined as a process whereby computing device 104 derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. In some cases, Processor 108 may use an image classifier to identify a key image in user data 116. As used herein, a “key image” is an element of visual data used to identify and/or match elements to each other. An image classifier may be trained with binarized visual data that has already been classified to determine key images in user data 116. “Binarized visual data” for the purposes of this disclosure is visual data that is described in binary format. For example, binarized visual data of a photo may be comprised of ones and zeroes wherein the specific sequence of ones and zeros may be used to represent the photo. Binarized visual data may be used for image recognition wherein a specific sequence of ones and zeroes may indicate a product present in the image. An image classifier may be consistent with any classifier as discussed herein. An image classifier may receive an input of user experience and output a key image of user data 116. An identified key image may be used to locate a data entry relating to the image data in user data, such as an image depicting a significant event. In an embodiment, image classifier may be used to compare visual data in user data 116 with visual data in another data set, such as previously inserted user data 116. In the instance of a video, Processor 108 may be used to identify a similarity between videos by comparing them. Processor 108 may be configured to identify a series of frames of video. The series of frames may include a group of pictures having some degree of internal similarity, such as a group of pictures having similar components, scenery, location and the like depicted within them or similar color profiles. In some embodiments, comparing series of frames may include video compression by inter-frame coding. The “inter” part of the term refers to the use of inter frame prediction. This kind of prediction tries to take advantage from temporal redundancy between neighboring frames enabling higher compression rates. Video data compression is the process of encoding information using fewer bits than the original representation. Any compression may be either lossy or lossless. Lossless compression reduces bits by identifying and eliminating statistical redundancy. No information is lost in lossless compression. Lossy compression reduces bits by removing unnecessary or less important information. Typically, a device that performs data compression is referred to as an encoder, and one that performs the reversal of the process (decompression) as a decoder. Data compression may be subject to a space-time complexity trade-off. For instance, a compression scheme for video may require expensive hardware for the video to be decompressed fast enough to be viewed as it is being decompressed, and the option to decompress the video in full before watching it may be inconvenient or require additional storage. Video data may be represented as a series of still image frames. Such data usually contains abundant amounts of spatial and temporal redundancy. Video compression algorithms attempt to reduce redundancy and store information more compactly.

With continued reference to FIG. 1, processing user data 116 may include classifying user data 116 to a confidence class, using a machine learning model, such as a classifier, to organize the confidence classes. As used in this disclosure, a “confidence class” is a grouping of user data 116 based on the particular issue that is described within user data 116. As a non-limiting example, confidence classes, may include social confidence, assertive confidence, financial confidence, self-image, work confidence that may be present within user data 116. A confidence classifier may be used to label various data present within user data 116. For example, data within user data 116 indicating that a user lacks proper communicative skills may be labeled with a social confidence label. In another non limiting example, data within user data 116 indicating that a user lacks proper assertion skills may be labeled with an assertive confidence label. A “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. Classifiers as described throughout this disclosure may be configured to output at least a datum that labels or otherwise identifies a set of data that are clustered together, found to be close under a distance metric as described below, or the like. For example, Processor 108 may generate and train a confidence classifier configured to receive user data 116 and output at least a confidence class. Processor 108 and/or another device may generate a classifier using a classification algorithm, defined as a process whereby a Processor 108 derives a classifier from training data. In some cases confidence classifier may use data to prioritize the order in of labels within user data 116. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. A confidence classifier may be trained with training data correlating user data 116 to confidence groupings, such as, social confidence, self-image confidence, assertive confidence and the like. Training data may be received from an external computing device, user input, and/or previous iterations of processing. A confidence classifier may be configured to input user data 116 and categorize components of user data 116 to one or more confidence groupings. Data classified in this disclosure may further be classified using fuzzy sets as described below. Fuzzy sets may be useful where data may fit into different categories and/or classes, or where data may be borderline in a category.

With continued reference to FIG. 1, Processor 108 may be configured to generate classifiers as described throughout this disclosure using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process for the purposes of this disclosure. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors for the purposes of this disclosure may be scaled, such that each vector represents each attribute along an equivalent scale of values. Each vector may be “normalized,” or divided by a “length” attribute, such as a length attribute l as derived using a Pythagorean norm:

$$l = \sqrt{{Σ}_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

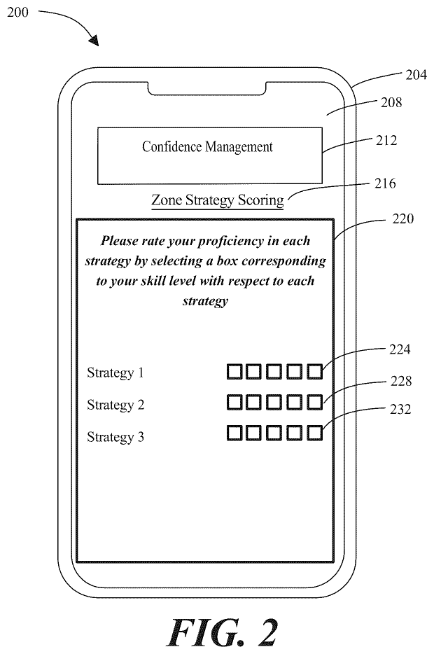

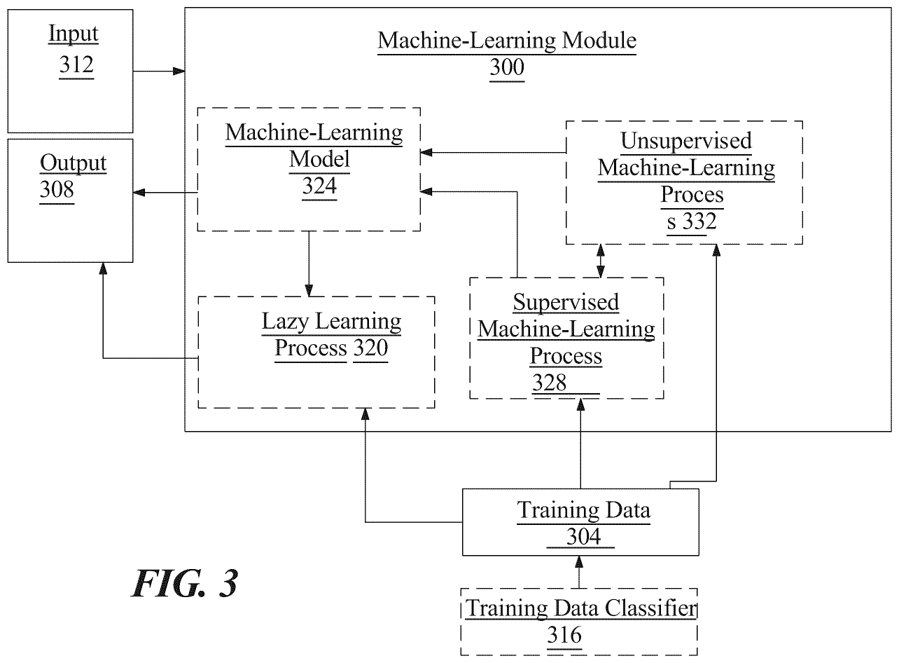

With continued reference to FIG. 1, receiving user data 116 may further include processing user data 116 using optical character recognition. Optical character recognition or optical character reader (OCR) includes automatic conversion of images of written (e.g., typed, handwritten or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes. in some cases OCR may be an “offline” process, which analyses a static document or image frame. In some cases, handwriting movement analysis can be used as input for handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition. in some cases, OCR processes may employ pre-processing of image component. Pre-processing process May include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from a background of image component. In some cases, binarization may be required for example if an employed OCR algorithm only works on binary images. In some cases. a line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image component. In some embodiments an OCR process will include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at a same scale as input glyph. Matrix matching may work best with typewritten text. In some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIGS. 3-5. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States. in some cases, OCR may employ a two-pass approach to character recognition. Second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks as taught in reference to FIGS. 2-4. In some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, OCR may be used to process data such as PDF files, images containing texts, lists of credit card transactions, documents indicating financial history and any other files or documents that may contain text. Computing device 104 may then convert the files mentioned above into text-based data that may be used for data manipulation later on.

With continued reference to FIG. 1, processor 108 may be configured to receive user data 116 as a function of an interaction between a user and a chatbot. For the purposes of this disclosure a “chatbot” is a computer program that simulates and processes human conversation. Chatbot may interact with a user in order to receive user data 116. In some cases, chatbot May simulate a human in order to receive user data 116 through a conversation that occurred with the user. As opposed to ordinarily typing in information, a chatbot may engage and stimulate a user such that a user may properly input information and not feel discouraged from doing so. In some cases, chatbot may ask a user a series of questions, wherein the series of questions are requests for data. The series of questions may mimic ordinary human interaction in order to engage a user into inputting data. Chatbot is described in further detail below. Chatbot may include a language processing module as described below. In some embodiments, chatbot may use a large language model to generate responses. A “large language model,” for the purposes of this disclosure, is a language model that has been trained using a large dataset contain a variety of different types of data. Large language model may include GPT, GPT-2, GPT-2, GPT-4, Bard, and the like. Large language models may use a transformer architecture. Transformer architectures may use an attention mechanism in order to determine what words to attend to when generating an output.

Still referring to FIG. 1, any data as described in this disclosure (e.g., user data) may be represented as a vector. As used in this disclosure, “vector” is a data structure that represents one or more quantitative values. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent, for instance as measured using cosine similarity as computed using a dot product of two vectors; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors for the purposes of this disclosure may be scaled, such that each vector represents each attribute along an equivalent scale of values. Each vector may be “normalized,” or divided by a “length” attribute, such as a length attribute l as derived using a Pythagorean norm:

$$l = \sqrt{{Σ}_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes.

With continued reference to FIG. 1, memory 112 contains instructions configuring processor 108 to generate zone strategies 140 based on the user data 116. “Zone strategies” for the purposes of this disclosure is data containing approaches and/or strategies that may aid a user in increasing or maintaining their confidence. Zone strategies 140 may contain at least one individual zone strategy 144. “Individual zone strategy” as described herein is data containing a singular approach or strategy that may aid a user in increasing or maintaining their confidence. Zone strategies 140 may contain at least one individual zone strategy 144 such as, but not limited to, strategies such as, focusing on progress and not perfection, using positive focus to celebrate achievements, keeping focus days free of stuff and messes, scheduling taking rejuvenating free days, delegating routine activities, developing new capabilities that drive future growth, using strategies to transform obstacles into solutions, connecting with professionals around you, focusing on achieving the first 80% of any project or activity, using a weekly planner to track results. Zone strategies 140 may further contain more than one individual zone strategies. Individual zone strategy 144 may contain steps or stages for a user to perform to complete the strategy. For example, individual zone strategy 144 containing a strategy to finish a project or activity as described above, may contain a first step instructing a user to start an activity in the morning, a second step instructing a user to create an outline, a third step to prioritize smaller tasks and so on. Zone strategies 140 may be specific to user data 116. For example, zone strategies 140 may contain strategies to improve or maintain social interactions when user data 116 contains data relating to social interactions. This may include, but is not limited to strategies such as, speaking in front of a mirror, engaging in more conversations, talking to strangers, speaking in smaller crowds and the like. Zone strategies 140 may include more than one individual zone strategies that are correlated to or associated with user data 116 wherein each individual zone strategy 144 is configured to help or improve the confidence or abilities of a user. Zone strategies 140 may be retrieved from a database. Zone strategies 140 may be generated by a user, such as a psychologist, a life coach, a mentor, a 3^{rd} party and the like. In addition, zone strategies 140 may be input into apparatus by a user, psychologist, life coach, mentor, 3^{rd} party and the like. Database 132 may include a multiplicity of individual zone strategies wherein each individual zone strategy 144 may be related to a particular topic. Zone strategies 140 may be selected from a multiplicity of individual zone strategies, wherein zone strategies 140 is one or more individual zone strategies that are related to or correspond to the goal of a user. The multiplicity of individual zone strategies may be stored on a database, wherein computing device 104 selects individual zone strategies that are associated with user data 116. In some cases, individual zone strategy 144 may contain a label that groups individual zone strategy 144 to a confidence class. Computing device 104 may then select zone strategies 140 wherein each individual zone strategy 144 corresponds to a label within user data 116 as described above. In some cases, generating zone strategies 140 may include obtaining a multiplicity of individual zone strategies from a database 132 and selecting at least one individual zone strategy 144 from the multiplicity of individual zone strategies. In some cases, selecting at least one individual zone strategy 144 from the multiplicity of individual zone strategies may include using a rule-based engine. Rule-based engine may include a zone strategy rule. As used in this disclosure, a “rule-based engine” is a system that executes one or more rules such as, without limitations, zone strategy rule, in a runtime production environment. As used in this disclosure, a “zone strategy rule” is a pair including a set of conditions and a set of actions, wherein each condition within the set of conditions is a representation of a fact, an antecedent, or otherwise a pattern, and each action within the set of actions is a representation of a consequent. In a non-limiting example, zone strategy rule may include a condition of “user inputs user data 116 corresponding to category or class X” pair with an action of “select at least one individual zone strategy 144 within the category or class X.” In another non-limiting example, user may input user data 116 having a user goal 136 of “self-confidence improvement” wherein input of said user goal 136 may execute a rule to receive zone strategies related to self-confidence improvement from a multiplicity of individual zone strategies as described below. In yet another non limiting example, zone strategy rule may include a condition wherein user inputs user data correlated to particular goal class paired with an action of “selecting at least one individual zone strategy associated with the particular goal class. In some embodiments, rule-based engine may execute one or more zone strategy rules if any conditions within one or more zone strategy rules are met. As a non-limiting example, one or more zone strategy rules may be implemented if one or more user data 116 are inputted.

With continued reference to FIG. 1, generating zone strategies 140 based on the user data 116 may include generating a goal classifier and classifying user goal 136 to a goal class. “Goal Class” as described in this disclosure is a grouping of goals based on the particular goal involved. As a non-limiting example, goal classes may include self-confidence improvement, social interaction improvement, any goals as described in this disclosure, and/or the like. Goal classifier may classify user goal 136 within user data 116 to one or more goal classes. For example, goal classifier may receive user goal 136 and may classify user goal 136 to a specific goal class such as self-confidence improvement, social interaction improvement and/or the like. Goal classifier may be trained using training data correlating a plurality user goals 136 to a plurality of goal classes. Goal classifier may be generated using any classifier or machine learning model as described within this disclosure. generating zone strategies 140 may further include assigning the at least a user goal 136 to a goal class. Additionally or alternatively, generating the zone strategies 140 may include generating the zone strategies 140 as a function of the assigning the at least a user goal to a goal class. In some cases, individual zone strategies 144 may be assigned to a goal class, wherein generating the zone strategies includes selecting at least one individual zone strategy from a multiplicity of individual zone strategies assigned to a goal class. In some cases, classifying the at least a user goal 136 further includes classifying using a goal classifier machine learning model. Classifying the at least a user goal 136 may include receiving goal classifier training data. Goal classifier training data may include a plurality of user goals correlated to a plurality of goal classes. In some cases, goal classifier training data may be received from a user, a third party, database, external computing devices, previous iterations of the function and/or the like. In some embodiments, goal classifier training data may be stored in a database. In some embodiments, goal classifier training data may be retrieved from a database. In some embodiments, user goal 136 may be stored in a database 132 and used as training data for future iterations. Similarly, training data may be created from previous iterations wherein a previous user goal 136 was received and stored on a database. Classifying the at least a user goal 136 may further include training a goal classifier machine learning model 148 as a function of the goal classifier training data and classifying the at least a user goal 136 as a function of the goal classifier machine learning model. In some embodiments, outputs of goal Classifier machine learning model 148 may be used to train goal classifier training data. In some cases generating zone strategies 140 as a function of the assigning at least a user goal 136 may include using a classifier as described in this disclosure.

With continued reference to FIG. 1, generating the zone strategies 140 may include generating the zone strategies 140 using a zone strategy machine learning model. Processor 108 may use a machine learning module, such as a machine learning module for the purposes of this disclosure, to implement one or more algorithms or generate one or more machine-learning models, such as an assessment machine learning model, to calculate at least one smart assessments. However, the machine learning module is exemplary and may not be necessary to generate one or more machine learning models and perform any machine learning described herein. In one or more embodiments, one or more machine-learning models may be generated using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories of data elements. Exemplary inputs and outputs may come from a database, such as any database 132 described in this disclosure, or be provided by a user. In other embodiments, a machine-learning module may obtain a training set by querying a communicatively connected database 132 that includes past inputs and outputs. Training data may include inputs from various types of databases, resources, and/or user inputs and outputs correlated to each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories of data elements by, for example, associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements. A machine learning module, such as zone strategy module, may be used to generate zone strategy machine learning model and/or any other machine learning model using training data. Zone strategy machine learning model may be trained by correlated inputs and outputs of training data. Training data may be data sets that have already been converted from raw data whether manually, by machine, or any other method. Zone strategy training data may be stored in a database. Zone strategy training data may also be retrieved from database.

With continued reference to FIG. 1, generating zone strategies 140 based on user data 116 may include receiving zone strategy training data. In an embodiment, zone strategy training data may include a plurality of user data 116 correlated to a plurality of zone strategies. For example, zone strategy training data may be used to show a particular user data 116 is correlated to one of a plurality of zone strategies, wherein each of the plurality of the zone strategies 140 contains strategies for a user that are related to user data 116. In some cases, training data may include a plurality of user goals that are correlated to a plurality of zone strategies. In some embodiments, zone strategy training data may be received from a user, third party, database, external computing devices, previous iterations of processing, and/or the like as described in this disclosure. zone strategy training data may further be comprised of previous iterations of user data 116 and/or zone strategies. Zone strategy training data may be stored in a database 132 and/or retrieved from a database. Generating zone strategies 140 may further include training a zone strategy machine learning model as a function of zone strategy training data and generating zone strategies 140 as a function of zone strategy machine learning model. In some cases, zone strategy training data may be trained through user input wherein a user input may determine if zone strategies 140 is accurate and/or applicable to the current user data 116. In some cases, zone strategies 140 may be generated using a lookup table. Processor 108 may be configured to lookup up particular zone strategies 140 or individual zone strategies 144 based on user goal 136. For example, a particular user goal 136 may be associated with a particular individual zone strategy 144, wherein zone strategies 140 contains at least on individual zone strategy. Lookup table includes any lookup table as described in this disclosure.

With continued reference to FIG. 1, memory 112 further contains instructions configuring processor 108 to receive a plurality of zone strategy scores 152 from a user as a function of zone strategies 140. “Zone strategy score,” as used herein, is a score that that is associated to each individual zone strategy 144 in zone strategies. Each zone strategy score 156 indicates a user's competence, experience, engagement, proficiency, familiarity and/or ability to perform with respect to each individual zone strategy 144 in zone strategies 140. For example, plurality of zone strategy scores 152 may contain a numerical score for a particular individual zone strategy 144 such as “using a weekly planner to track results” wherein the score indicates a user's engagement with said individual zone strategy. In said example, a lower score may be associated with a particular individual zone strategy 144 if a user does not regularly engage or accomplished said strategy. Plurality of zone strategy scores 152 may be numerical scores ranging from 1-5, 1-10, and/or 1-100 wherein a lower score may indicate that a user is not actively engaging in the strategy and a higher numerical score may indicate a higher involvement or engagement of the strategy. In some cases, plurality of zone strategy scores 152 may contain data such as “low” “medium” or “high” wherein an indication of “low” may indicate low involvement of the strategy and an indication of “high” may indicate a high involvement of the individual strategy. Plurality of zone strategy scores 152 may be used to indicate a user's involvement in each individual strategy. In some cases at least one zone strategy score 156 of the plurality of zone strategy scores 152 is correlated to an individual zone strategy 144 of the zone strategies. Receiving a plurality of zone strategy scores 152 may include receiving the plurality of zone strategy scores 152 from a user. Computing device 104 and/or apparatus 100 may request input from a user wherein a user may input plurality of zone strategy scores. Apparatus 100 may contain interactive components as described below wherein a user may interact with interactive components in order to rank or score each individual zone strategy. In some cases, plurality of zone strategy scores 152 may contain previous score data, wherein previous score data is data of a previous set of plurality of zone strategy scores 152 of a user. Previous score data may include scores of a previous iteration of the process, wherein a user entered plurality of zone strategy scores 152 on a previous date or before the current iteration. Previous score data may be retrieved from a database. Plurality of zone strategy scores 152 may be transmitted to a database 132 and used as previous score data for a future iteration.

With continued reference to FIG. 1, receiving plurality of zone strategy scores 152 may include receiving a plurality of zone strategy scores 152 as a function of zone strategies 140 and the user data 116. Computing device 104 may generate plurality of zone strategy scores 152 as opposed to a user, wherein computing device 104 may use a classifier, or a machine learning model as described in this disclosure to generate zone strategy scores 152 based on user data 116. For example, computing device 104 may generate a lower zone strategy score 156 for a particular individual zone strategy 144 when user data 116 indicates that a user is struggling with a particular confidence related issue. In some cases plurality of zone strategy scores 152 may be received by utilizing a score machine learning model. Score machine learning model may be trained with a score training data. score training data may include a plurality of user data 116 and a plurality of the zone strategies 140 correlated to a plurality of the plurality of zone strategy scores. In some embodiments, score training data may include a plurality of user data 116 correlated to a plurality of zone strategy scores. In an embodiment, score training data may be used to show that a particular datum or data within user data 116 is associated with zone strategy score. In some instances, score training data may be generated from previous iterations of score machine learning inputs and respective outputs. In some embodiments, score training data may include a combination of historical inputs correlated to historical outputs that fall within a threshold value of an output associated therewith. As a non-limiting example, a first iteration of score machine learning model may have a historical input that may have a particular output, but the second iteration may have a different, distinct, input/output combination. For a third iteration, score machine learning model may be trained with training data that correlates inputs from the first iteration and outputs of the second iteration, as long as outputs of the second iteration fall within a threshold value of the outputs of the first iteration. Combining historical inputs and outputs may add variance to score machine learning model to create a more robust machine learning model.

With continued reference to FIG. 1, zone strategy scores 152 may include scores from a previous date and/or previous iteration wherein a user may view previous scores generated and the change in scores over a predetermined amount of time. For example, zone strategy scores 152 may include a current score from the current iteration indicating a particular score and a previous score from a previous iteration indicating a similar particular score. A user may be able to use the scores for comparison and to determine if the user has progressed since the previous iteration. In some cases zone strategy scores 152 may be stored and/or retrieved on a database and/or a storage wherein computing device may store zone strategy score 152 and display them to a user as a previous score in a future iteration. In some cases zone strategy scores may contain and/or be associated with a particular date wherein a user may be able to view the time or date of the previous score and the amount of progress or regress since the particular date.

With continued reference to FIG. 1, memory 112 further contains instructions configuring processor 108 to determine follow through data 160 as a function of the plurality of zone strategy scores 152 and the zone strategies. “Follow through data” for the purposes of this disclosure are instructions configured to aid a user in improving on each individual zone strategy 144 in zone strategies. A combination of plurality of zone strategy scores 152 and zone strategies 140 may indicate that a user is competent or engaged in one individual zone strategy 144 while not engaged or component in another individual zone strategy. Follow through data 160 may provide instructions on how a user may improve on each individual zone strategy. Additionally or alternatively, follow through data 160 may include instructions that are specific to each zone strategy score 156 that is associated with each individual zone strategy. For example, a user who may have a zone strategy score 156 of 2 out of 5 in a particular individual zone strategy 144 may receive differing instructions in follow through data 160 as a user who may have a zone strategy score 156 of 4 out of 5 for a differing particular individual zone strategy. Follow through data 160 may include data on how a user may improve on each individual zone strategy 144 and how to improve the score for future iterations. This may include more detailed instructions on how to be proficient in an individual zone strategy 144 or instructions signifying that a particular individual zone strategy 144 may need to be prioritized over another individual zone strategy. In a non-limiting example, follow through data 160 may instruct a user on how to begin a project or how to properly designate time with respect to an individual zone strategy, such as an individual zone strategy 144 instructing a user to focus on achieving the first 80% of any project or activity. Continuing, the example, follow through data 160 may instruct a user to attend a course when a user has a low zone strategy score 156. However, follow through data 160 may instead instruct a user on a simpler task and/or set of instructions if a user has a higher zone strategy score 156. In some cases, determining follow through data 160 may further include determining a change in previous score data and plurality of zone strategy scores 152. A change in previous score data and plurality of zone strategy scores 152 may indicate that a user has improved since the last iteration. For example, previous score data containing a score of 2 and plurality of zone strategy scores 152 containing a zone strategy score 156 of 4 with relation to individual zone strategy 144 may indicate that a user has improved since the previous iteration. Follow through data 160 may be generated as a function of the comparison wherein follow through data 160 may contain instructions and/or steps on how a user may continue to improve or maintain their goals. In some cases, the comparison between previous score data and zone strategy score 156 may indicate that a user has decreased their improvement since the previous iteration. As a result, computing device 104 may generate follow through data that is responsive to the change in zone strategy score in order to ensure that a user improves their plurality of zone strategy scores 152 for the next iteration. In some cases, follow through data generated as a function of the comparison between previous score data and plurality of zone score 152 may contain instructions that are different from follow through data 160 generated as a function of plurality of zone strategy scores 152. Additionally or alternatively, follow through data 160 generated on a second, third, or fourth (and so on) iteration wherein previous score data may retrieved, may be different from follow through data 160 generated on a first iteration. Follow through data may be generated using a machine learning model as a function of the comparison between previous score data and plurality of zone strategy scores. Training data may contain a plurality of comparisons between previous score data and zone strategies 140 correlated to a plurality of follow through data, wherein a particular comparison may indicate a particular follow through data. In some embodiments, training data may be received from a user, third party, database, external computing devices, previous iterations of processing, and/or the like as described in this disclosure. Training data may be stored in a database 132 and/or retrieved from a database. In some cases, follow through data 160 may be determined using a lookup table where in a particular individual zone strategy 144 and/or zone strategy score 156 may be used to lookup a particular follow through data 160. Additionally or alternatively, Follow through data 160 may be determined using a lookup table wherein each individual zone strategy 144 of zone strategies 144 and/or each individual zone score 156 of plurality of zone scores 152 is used to lookup follow through data

Still referring to FIG. 1, goals and/or domains within which to measure one or more zone strategies may include, without limitation, attribute clusters and/or outlier clusters as identified and/or described in U.S. Nonprovisional application Ser. No. 18/141,296, filed on Apr. 28, 2023 with attorney docket number 1452-022USU1 and entitled “SYSTEMS AND METHODS FOR DATA STRUCTURE GENERATION,” the entirety of which is incorporated by reference herein.

With continued reference to FIG. 1, follow through data 160 may include improvement data. “Improvement data” for the purposes of this disclosure is data relating to the improvement of a user over a given period of time. Improvement data 164 may be determined by comparing current data 124 from user data 116 and previously entered user data 128 from current data. Improvement data 164 may indicate or contain data that a user has improved over a particular period of time based on the current data 124 and previously entered user data 116. Improvement data 164 may also indicate that a goal sought in the current iteration is different than a goal sought in a previous iteration. Improvement data 164 may also be determined based on previous score data generated or received from a previous iteration of the processing, and plurality of zone strategy scores 152 generated from the current iteration of the processing. Improvement data 164 may include data signifying to a user that the user has improved on their goals or their confidence since a previous iteration. Improvement data 164 may further include data signifying that a user has maintained their goals or has regressed since the previous iteration. Improvement data 164 may be generated by determining a difference between previous score data and plurality of zone strategy scores 152 and outputting improvement data 164 as a function of the difference. For example, when previous score data indicates that a user had a zone strategy score 156 of 3 out of 5 on a previous iteration and a user may now have a score of 1 on the current iteration, improvement data 164 may be generated as function of the difference which would be −2. Improvement data 164 may be generated using a lookup table wherein each difference is correlated to data within the lookup table. A “lookup table” for the purposes of this disclosure is an array of predetermined values wherein each value may be looked up using a key corresponding to that specific value. For example, a value of −2 as described above may contain data within a lookup table of improvement data 164 that is correlated to a drop in one's improvement. Data within the lookup table may include instructions or steps helping a user fix or maintain the difference generated by previous score data and plurality of zone strategy scores 156. For example, on a difference of −2, computing device may locate data correlated to a −2 difference, wherein the data may include instructions on how to prevent a lowering of one's plurality of zone strategy scores 156 in the future. In another non-limiting example, when a difference of +2 is calculated, data pertaining to a +2 difference on lookup table may include data and/or instructions on how to maintain one's plurality of zone strategy scores 156 and the like. The lookup table may be retrieved from a database 132 and/or generated by a user. In some embodiments, at least a processor 108 may ‘lookup’ a given difference to one or more lists improvement data.

With continued reference to FIG. 1, follow through data 160 may include at least one follow through plan. A “follow through plan” as described in this disclosure is an individual plan within follow through data 160 that is correlated to at least one individual zone strategy 144. In some cases follow through data 160 may include a plurality of follow through plans wherein each follow through plan 168 of the plurality of follow through plans is correlated to at least one individual zone strategy 144 within zone strategies 140. In an embodiment, follow through plan 168 may be used to instruct a user on how to improve on a particular individual zone strategy 144. In instances wherein zone strategies 140 may contain more than one individual zone strategies 144, follow through data 160 may contain multiple follow through plans wherein each follow through plan 168 may contain data instructing a user on how to improve on a particular individual zone strategy 144. In some cases, follow through data 160 may contain one follow through plan, wherein the one follow through plan 168 is a set of instructions that that are universal and/or encompass multiple individual zone strategies 144 within zone strategies 140.

With continued reference to FIG. 1, follow through data 160 may be determined as a function of the plurality of zone strategy scores 152 and zone strategies 140 using a follow through machine learning model. Determining follow through data 160 as a function of plurality of zone strategy scores 152 and zone strategies 140 includes receiving follow through training data 176. In an embodiment, follow through training data 176 may include a plurality of the zone strategies 140 and a plurality of the plurality of zone strategy scores 152 correlated to a plurality of follow through data. For example, follow through training data 176 may be used to show a particular zone strategies 140 and plurality of zone strategy scores 152 that is correlated to one of a plurality of follow through data. In an embodiment, follow through data 160 may be used to instruct a user on how to improve or increase their zone strategy scores that are associated to each individual zone strategy. In some embodiments, follow through training data 176 may be received from a user, third party, database, external computing devices, previous iterations of processing, and/or the like as described in this disclosure. Follow through training data 176 may further be comprised of previous iterations of zone strategies 140 and plurality of zone strategy scores 152 and follow through data. Follow through training data 176 may be stored in a database 132 and retrieved from a database. Determining follow through data 160 may further include training a follow through machine learning model 172 as a function of follow through training data 176 and determining follow through data 160 as a function of follow through machine learning model. In some cases, follow through training data 176 may be trained through user input wherein a user may determine if an output containing follow through data 160 is accurate and/or applicable to the current goal of a user.

With continued reference to FIG. 1, memory 112 further contains instructions to create a user interface data structure 180. As used in this disclosure, “user interface data structure” is a data structure representing a specialized formatting of data on a computer configured such that the information can be effectively presented for a user interface. User interface structure includes zone strategies 140 and follow through data. In some cases, user interface data structure 180 further includes any data as described in this disclosure, such as user data, plurality of zones strategy scores and the like. Additionally, or alternatively, Processor 108 may be configured to generate user interface data structure 180 using any combination of data as described in this disclosure

With continued reference to FIG. 1, memory 112 further contains instructions to transmit the follow through data, the zone strategies 140 and the user interface data structure 180. Transmitting may include, and without limitation, transmitting using a wired or wireless connection, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. Processor 108 may transmit the data described above to a database 132 wherein the data may be accessed from a database, Processor 108 may further transmit the data above to a device display or another computing device.

With continued reference to FIG. 1, apparatus 100 further includes a graphical user interface 184 (GUI) communicatively connected to at least a processor. For the purposes of this disclosure, a “user interface” is a means by which a user and a computer system interact; for example, through the use of input devices and software. A user interface may include graphical user interface 184, command line interface (CLI), menu-driven user interface, touch user interface, voice user interface (VUI), form-based user interface, any combination thereof and the like. In some embodiments, a user may interact with the user interface using a computing device 104 distinct from and communicatively connected to at least a processor. For example, a smart phone, smart, tablet, or laptop operated by the user and/or participant. A user interface may include one or more graphical locator and/or cursor facilities allowing a user to interact with graphical models and/or combinations thereof, for instance using a touchscreen, touchpad, mouse, keyboard, and/or other manual data entry device. A “graphical user interface,” as used herein, is a user interface that allows users to interact with electronic devices through visual representations on. In some embodiments, GUI 184 may include icons, menus, other visual indicators, or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface 184. skilled in the art, upon reviewing the entirety of this disclosure, will be aware of various ways in which a graphical user interface 184 and/or elements thereof may be implemented and/or used as described in this disclosure.

With continued reference to FIG. 1, GUI 184 is configured to receive the user interface structure and display the zone strategies 140 and the follow through data 160 as a function of the user interface data structure 180. GUI 184 may be displayed on a display device. Display device may include, but is not limited to, a smartphone, tablet, laptop, monitor, tablet, and the like. Display device may include a separate device that includes a transparent screen configured to display computer generated images and/or information. In some cases, GUI 184 may be displayed on a plurality of display devices. In some cases, GUI 184 may contain an interaction component. “Interaction component” for the purposes of this disclosure is a device or a computer program that is capable of allowing a user to interact with GUI 184. Interaction component may include a button or similar clickable elements wherein the clicking of the button may initiate a response or a command. In some cases, interaction component may allow a user to input plurality of zone strategy scores, wherein interaction component may include a text box or clickable buttons that allow a user to input plurality of strategy scores. In some cases, interaction component may include multiple check boxes on a display, wherein the clicking of a checkbox may indicate to computing device 104 that a specific input was entered. For example, a checking of a checkbox having the number “one” displayed on it, may indicate to computing device 104 that user has entered a score of “1”. Interaction component may further contain drop down menus where a user may choose from a list of commands wherein the list of commands may perform different functions. For example, a command may include pausing or stopping the data that is being displayed. In some cases, a command may allow user to process another iteration or go back and input more data. Interaction feature may further include dialog or comment boxes wherein users may enter comments about data that is displayed. Comment boxes may be consistent with user input as described. Interaction component may further allow a user to modify or change data within follow through data. In some cases, interaction component may be used to provide feedback to an operator. In some cases, interaction component may allow a user to provide feedback on follow through data, plurality of zone strategy scores 152 and the like such that machine learning model may be trained to provide better results. In some embodiments, configuring one or more interaction components may include selecting one or more interaction components properties as a function of follow through data. In a non-limiting example, an interaction component with a larger size may be selected to display a first instruction and/or follow through plan 168 of follow through data 160 and another interaction component with a smaller size may be selected to display a second instruction of follow through data 160 and/or a second follow through plan. Other interaction components properties may include, without limitation, color, content, function, animation, and the like thereof.

Referring now to FIG. 2, an exemplary embodiment of a GUI 200 on a display device 204 is illustrated. GUI is configured to receive the user interface structure as discussed above and display the zone strategies and the follow through data as a function of the user interface data structure. Display device 204 may include, but is not limited to, a smartphone, tablet, laptop, monitor, tablet, and the like. Display device 204 may further include a separate device that includes a transparent screen configured to display computer generated images and/or information. In some cases, GUI may be displayed on a plurality of display devices. In some cases, GUI may display data on separate windows 208. A “window” for the purposes of this disclosure is the information that is capable of being displayed within a border of device display. A user may navigate through different windows 208 wherein each window 208 may contain new or differing information or data. For example, a first window may display the zone strategies as described in this disclosure, whereas a second window may display the follow through data as described in this disclosure. A user may navigate through a first second, third and fourth window (and so on) by interacting with GUI 200. For example, a user may select a button or box signifying a next window on GUI, wherein the pressing of the button may navigate a user to another window. In some cases, GUI may further contain event handlers, wherein the placement of text within a textbox may signify to computing device to display another window. An “event handler” as used in this disclosure is a callback routine that operates asynchronously once an event takes place. Event handlers may include, without limitation, one or more programs to perform one or more actions based on user input, such as generating pop-up windows, submitting forms, requesting more information, and the like. For example, an event handler may be programmed to request more information or may be programmed to generate messages following a user input. User input may include clicking buttons, mouse clicks, hovering of a mouse, input using a touchscreen, keyboard clicks, an entry of characters, entry of symbols, an upload of an image, an upload of a computer file, manipulation of computer icons, and the like. For example, an event handler may be programmed to generate a notification screen following a user input wherein the notification screen notifies a user that the data was properly received. In some embodiments, an event handler may be programmed to request additional information after a first user input is received. In some embodiments, an event handler may be programmed to generate a pop-up notification when a user input is left blank. In some embodiments, an event handler may be programmed to generate requests based on the user input. In this instance, an event handler may be used to navigate a user through various windows wherein each window may request or display information to or form a user. In this instance window 208 displays an identification field 212 wherein the identification field signifies to a user, the particular action/computing that will be performed by a computing device. In this instance identification field 212 contains information stating “confidence management” wherein a user may be put on notice that any information being received or displayed will be used for confidence management. Identification field 212 may be consistent throughout multiple windows 212. Additionally, in this instance window may display a sub identification field 216 wherein the sub identification field may indicate to a user the type of data that is being displayed or the type of data that is being received. In this instance, sub identification field 220 contains “zone strategy scoring”. This may indicate to a user that computing device may be receiving data for plurality of zone strategy scores as described above. Additionally, window 208 may contain an instruction prompt 220 wherein instruction prompt is configured to instruct a user on how to receive or display the data that is generated by computing device. In this instance, instruction prompt 220 instructs a user to input zone strategies wherein zone strategies may contain one more individual strategies. In this instance, a user is given a first row of check boxes 224 such that a user may rate strategy 1. A user is also given a second row of check boxes wherein a user may rate strategy 2, A user is also given a third row of check boxes, wherein a user may rate strategy 3. Each individual check box of the row of checkboxes 224,228,232 may signify a particular score, wherein the checking of one box may signify a lower score and, the checking of a second box may signify a higher score. GUI 200 may be configured to receive input from a user, wherein the input may be used for data manipulation. For example, GUI 200 may receive user data from a user as described above, wherein user data may be used for processing of data. GUI may contain an interaction component as described in this disclosure wherein the interaction component is configured to receive data from a user and allow a user to manipulate data and provide feedback.

Referring now to FIG. 3, an exemplary embodiment of a machine-learning module 300 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 304 to generate an algorithm that will be performed by a computing device/module to produce outputs 308 given data provided as inputs 312; this is in contrast to a non-machine learning software program where the commands to be executed are determined in advance by a user and written in a programming language.

Still referring to FIG. 3, “training data,” as used herein, is data containing correlations that a machine-learning process may use to model relationships between two or more categories of data elements. For instance, and without limitation, training data 304 may include a plurality of data entries, each entry representing a set of data elements that were recorded, received, and/or generated together; data elements may be correlated by shared existence in a given data entry, by proximity in a given data entry, or the like. Multiple data entries in training data 304 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 304 according to various correlations; correlations may indicate causative and/or predictive links between categories of data elements, which may be modeled as relationships such as mathematical relationships by machine-learning processes as described in further detail below. Training data 304 may be formatted and/or organized by categories of data elements, for instance by associating data elements with one or more descriptors corresponding to categories of data elements. As a non-limiting example, training data 304 may include data entered in standardized forms by persons or processes, such that entry of a given data element in a given field in a form may be mapped to one or more descriptors of categories. Elements in training data 304 may be linked to descriptors of categories by tags, tokens, or other data elements; for instance, and without limitation, training data 304 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively, or additionally, and continuing to refer to FIG. 3, training data 304 may include one or more elements that are not categorized; that is, training data 304 may not be formatted or contain descriptors for some elements of data. Machine-learning algorithms and/or other processes may sort training data 304 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 304 to be made applicable for two or more distinct machine-learning algorithms as described in further detail below. Training data 304 used by machine-learning module 300 may correlate any input data as described in this disclosure to any output data as described in this disclosure. As a non-limiting illustrative example, inputs may include inputs such as learning data and output may include post action plan data.

Further referring to FIG. 3, training data may be filtered, sorted, and/or selected using one or more supervised and/or unsupervised machine-learning processes and/or models as described in further detail below; such models may include without limitation a training data classifier 316. Training data classifier 316 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 300 may generate a classifier using a classification algorithm, defined as a process whereby a computing device and/or any module and/or component operating thereon derives a classifier from training data 304. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 316 may classify elements of training data to post action plans and specific types of post action plans and/or other analyzed items and/or phenomena for which a subset of training data may be selected.

Still referring to FIG. 3, machine-learning module 300 may be configured to perform a lazy-learning process 320 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 304. Heuristic may include selecting some number of highest-ranking associations and/or training data 304 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 3, machine-learning processes as described in this disclosure may be used to generate machine-learning models 324. A “machine-learning model,” as used in this disclosure, is a mathematical and/or algorithmic representation of a relationship between inputs and outputs, as generated using any machine-learning process including without limitation any process as described above and stored in memory; an input is submitted to a machine-learning model 324 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 324 may be generated by creating an artificial neural network, such as a convolutional neural network comprising an input layer of nodes, one or more intermediate layers, and an output layer of nodes. Connections between nodes may be created via the process of “training” the network, in which elements from a training data 304 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 3, machine-learning algorithms may include at least a supervised machine-learning process 328. At least a supervised machine-learning process 328, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include learning datum as described above as inputs, post action plan data as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 304. Persons skilled in the art, upon reviewing the entirety of this disclosure, will be aware of various possible variations of at least a supervised machine-learning process 328 that may be used to determine relation between inputs and outputs. Supervised machine-learning processes may include classification algorithms as defined above.

Further referring to FIG. 3, machine learning processes may include at least an unsupervised machine-learning processes 332. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 3, machine-learning module 300 may be designed and configured to create a machine-learning model 324 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 3, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

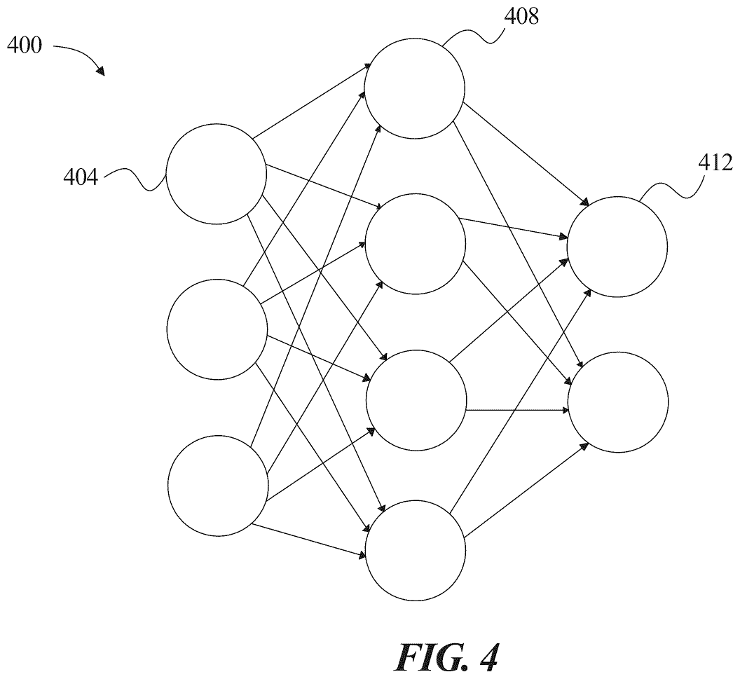

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

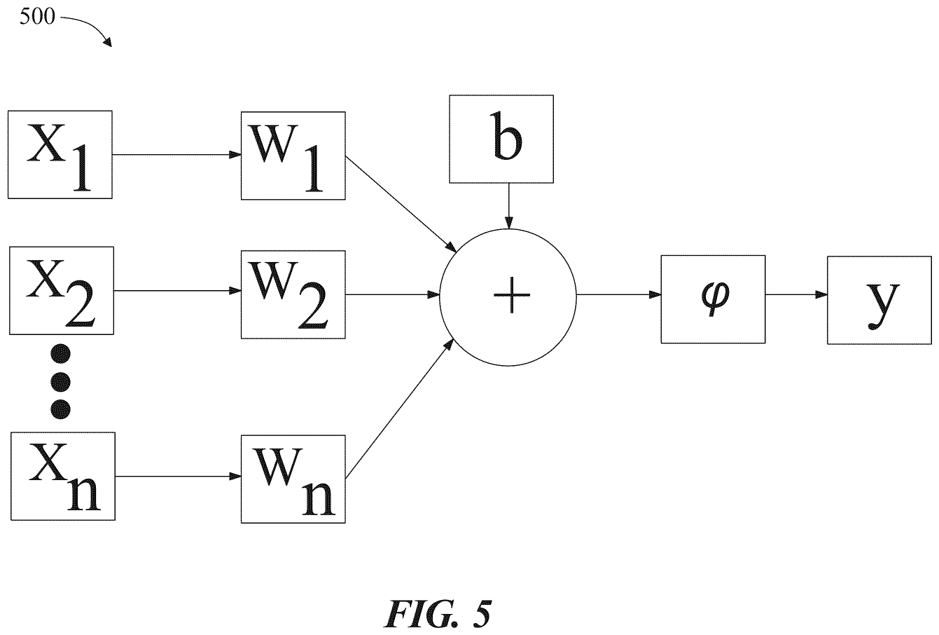

Referring now to FIG. 5, an exemplary embodiment of a node 500 of a neural network is illustrated. A node may include, without limitation a plurality of inputs x, that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max (0, x), a “leaky” and/or “parametric” rectified linear unit function such as ƒ(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{Σ}_{i} {x}_{i}}$$

where the inputs to an instant layer are xi, a swish function such as ƒ(x)=x*sigmoid (x), a Gaussian error linear unit function such as

$$f ( x ) = a ( 1 + tanh ( \sqrt{2 / π} ( x + b {x}^{r} ) ) )$$

for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xi that may be used as activation functions. As a non-limiting and illustrative example, node may perform a weighted sum of inputs using weights w′, that are multiplied by respective inputs xi. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

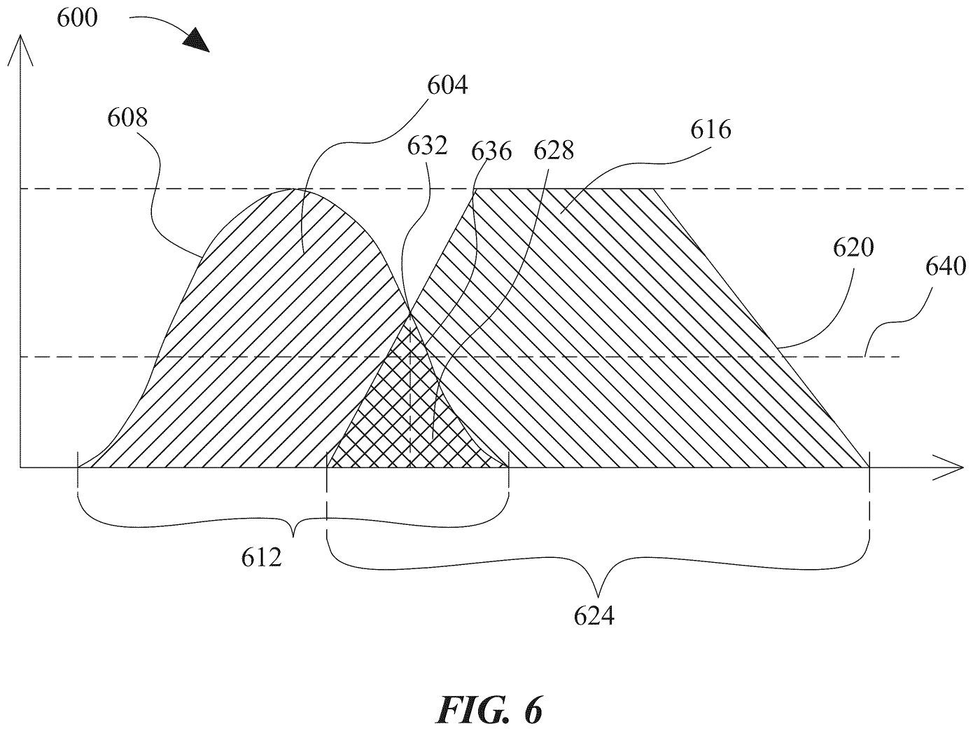

Referring to FIG. 6, an exemplary embodiment of fuzzy set comparison 600 is illustrated. A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 6, first fuzzy set 604 may represent any value or combination of values as described above, including output from one or more machine-learning models, image data, user data, and a predetermined class, such as without limitation of recommendation. A second fuzzy set 616, which may represent any value which may be represented by first fuzzy set 604, may be defined by a second membership function 620 on a second range 624; second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 628 that overlaps, first membership function 608 and second membership function 620 may intersect at a point 632 representing a probability, as defined on probability interval, of a match between first fuzzy set 604 and second fuzzy set 616. Alternatively or additionally, a single value of first and/or second fuzzy set may be located at a locus 636 on first range 612 and/or second range 624, where a probability of membership may be taken by evaluation of first membership function 608 and/or second membership function 620 at that range point. A probability at 628 and/or 632 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, threshold may indicate a sufficient degree of overlap between an output from one or more machine-learning models and/or image data, user data, verifier location, network latency, and a predetermined class, such as without limitation recommendation goal class, for combination to occur as described above. Alternatively or additionally, each threshold may be tuned by a machine-learning and/or statistical process, for instance and without limitation as described in further detail below.

Further referring to FIG. 6, in an embodiment, a degree of match between fuzzy sets may be used to classify image data, user data, or any other data described herein. For instance, if a user has a fuzzy set matching image data, user data, at least a fuzzy set by having a degree of overlap exceeding a threshold, processor 108 may classify, image data, user data, at least a user data as belonging to the achievable goal class. Where multiple fuzzy matches are performed, degrees of match for each respective fuzzy set may be computed and aggregated through, for instance, addition, averaging, or the like, to determine an overall degree of match.

Still referring to FIG. 6, in an embodiment, an image data, user data, or any other data may be compared to multiple goal class fuzzy sets. For instance, image data or user data may be represented by a fuzzy set that is compared to each of the multiple goal class fuzzy sets; and a degree of overlap exceeding a threshold between the image data, user data fuzzy set and any of the multiple goal class fuzzy sets may cause processor 108 to classify the image data or user data as belonging to achievable categorization. For instance, in one embodiment there may be two goal class fuzzy sets, representing respectively entity-specific categorization and a non-entity specific categorization. First entity-specific goal class may have a first fuzzy set; Second entity-specific goal class may have a second fuzzy set; and image data or user data may have an image data, or user data set. Processor 108, for example, may compare an image data or user data fuzzy set with each of goal class fuzzy set and in goal class fuzzy set, as described above, and classify image data, or user data to either, both, or neither of goal class nor in goal class. Machine-learning methods as described throughout may, in a non-limiting example, generate coefficients used in fuzzy set equations as described above, such as without limitation x, c, and σ of a Gaussian set as described above, as outputs of machine-learning methods. Likewise, image data, or user data may be used indirectly to determine a fuzzy set, as image data, or user data fuzzy set may be derived from outputs of one or more machine-learning models that take the image data, or user data directly or indirectly as inputs.

Still referring to FIG. 6, a computing device may use a logic comparison program, such as, but not limited to, a fuzzy logic model to determine a recommendation response. An recommendation response may include, but is not limited to, very unlikely, unlikely, likely, and very likely, and the like; each such recommendation response may be represented as a value for a linguistic variable representing recommendation response or in other words a fuzzy set as described above that corresponds to a degree of matching as calculated using any statistical, machine-learning, or other method that may occur to a person skilled in the art upon reviewing the entirety of this disclosure. In other words, a given element of image data, or user data may have a first non-zero value for membership in a first linguistic variable value such as “very likely” and a second non-zero value for membership in a second linguistic variable value such as “very unlikely” In some embodiments, determining a goal class may include using a linear regression model. A linear regression model may include a machine learning model. A linear regression model may be configured to map data of image data, device identification, verifier location, network latency, such as degree of . . . to one or more recommendation parameters. A linear regression model may be trained using a machine learning process. A linear regression model may map statistics such as, but not limited to, quality of image data, or user data. In some embodiments, determining a recommendation of image data, or user data may include using a recommendation classification model. A recommendation classification model may be configured to input collected data and cluster data to a centroid based on, but not limited to, frequency of appearance, linguistic indicators of quality, and the like. Centroids may include scores assigned to them such that quality of image data, or user data may each be assigned a score. In some embodiments recommendation classification model may include a K-means clustering model. In some embodiments, recommendation classification model may include a particle swarm optimization model. In some embodiments, determining the recommendation of an image data, or user data may include using a fuzzy inference engine. A fuzzy inference engine may be configured to map one or more image data or user data elements using fuzzy logic. In some embodiments, image data, or user data may be arranged by a logic comparison program into recommendation arrangement. An “recommendation arrangement” as used in this disclosure is any grouping of objects and/or data based on skill level and/or output score. This step may be implemented as described above in FIGS. 1-5. Membership function coefficients and/or constants as described above may be tuned according to classification and/or clustering algorithms. For instance, and without limitation, a clustering algorithm may determine a Gaussian or other distribution of questions about a centroid corresponding to a given degree of matching level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 6, an inference engine may be implemented according to input and/or output membership functions and/or linguistic variables. For instance, a first linguistic variable may represent a first measurable value pertaining to image data, device identification, verifier location, network latency, such as a degree of matching of an element, while a second membership function may indicate a degree of in recommendation of a subject thereof, or another measurable value pertaining to image data or user data. Continuing the example, an output linguistic variable may represent, without limitation, a score value. An inference engine may combine rules, such as: “if image is likely this verifier, device is highly likely the verifier's device, location is likely correct, and network latency is likely correct, then verifier is highly likely to be identified”—the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max(a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

Further referring to FIG. 6, image data or user data to be used may be selected by user selection, and/or by selection of a distribution of output scores, such as 100% very likely, 100% very unlikely, or the like. Each goal class may be selected using an additional function as described above.

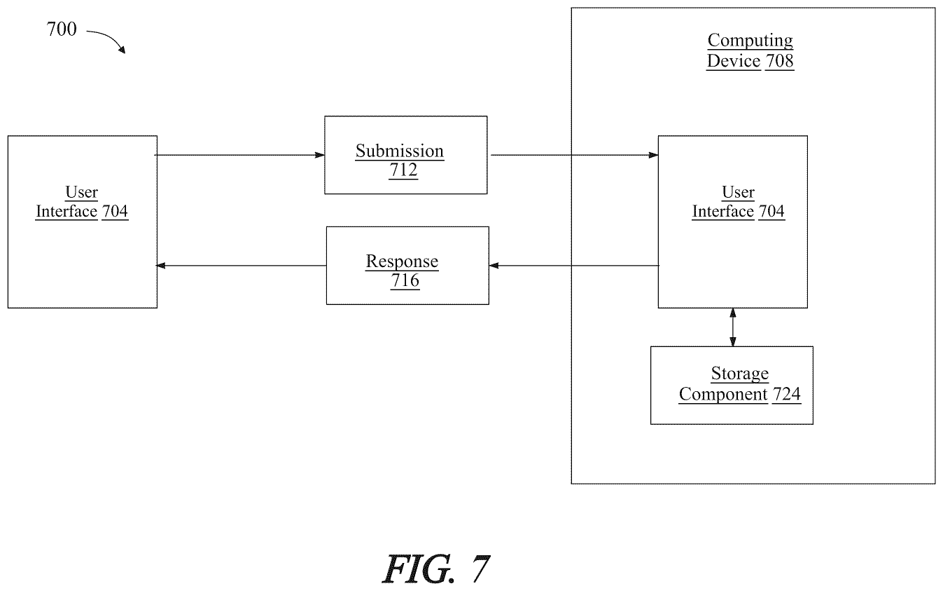

Referring to FIG. 7, a chatbot system 700 is schematically illustrated. According to some embodiments, a user interface 704 may be communicative with a computing device 708 that is configured to operate a chatbot. In some cases, user interface 704 may be local to computing device 708. Alternatively or additionally, in some cases, user interface 704 may remote to computing device 708 and communicative with the computing device 708, by way of one or more networks, such as without limitation the internet. Alternatively or additionally, user interface 704 may communicate with user device 708 using telephonic devices and networks, such as without limitation fax machines, short message service (SMS), or multimedia message service (MMS). Commonly, user interface 704 communicates with computing device 708 using text-based communication, for example without limitation using a character encoding protocol, such as American Standard for Information Interchange (ASCII). Typically, a user interface 704 conversationally interfaces a chatbot, by way of at least a submission 712, from the user interface 708 to the chatbot, and a response 716, from the chatbot to the user interface 704. In many cases, one or both of submission 712 and response 716 are text-based communication. Alternatively or additionally, in some cases, one or both of submission 712 and response 716 are audio-based communication.

Continuing in reference to FIG. 7, a submission 712 once received by computing device 708 operating a chatbot, may be processed by a processor 720. In some embodiments, processor 720 processes a submission 712 using one or more of keyword recognition, pattern matching, and natural language processing. In some embodiments, processor employs real-time learning with evolutionary algorithms. In some cases, processor 720 may retrieve a pre-prepared response from at least a storage component 724, based upon submission 712. Alternatively or additionally, in some embodiments, processor 720 communicates a response 716 without first receiving a submission 712, thereby initiating conversation. In some cases, processor 720 communicates an inquiry to user interface 704; and the processor is configured to process an answer to the inquiry in a following submission 712 from the user interface 704. In some cases, an answer to an inquiry present within a submission 712 from a user interface 704 may be used by computing device 708 as an input to another function.

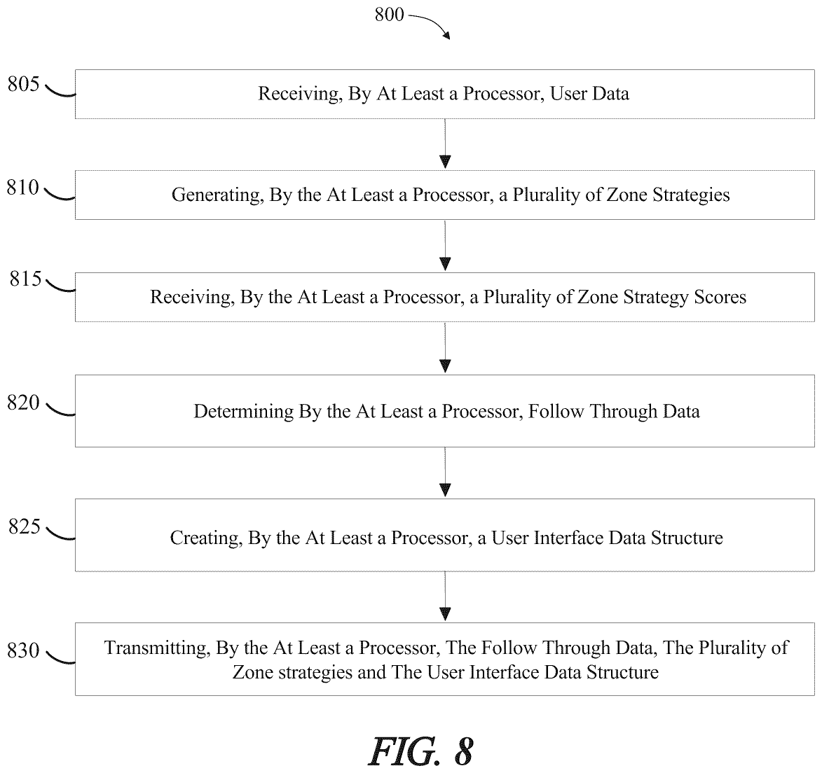

Referring now To FIG. 8, an exemplary method 800 for confidence management is illustrated by way of a flow diagram. At step 805, method 800 includes receiving, by at least a processor, user data, wherein the user data includes at least a user goal. In some embodiments, user data further comprises assessment data wherein assessment data includes physiological traits of a user. In some embodiments, receiving, by the at least a processor, user data further includes, receiving user data from a database, wherein the user data includes current data and a plurality of previously entered user data. In some embodiments, receiving by the at least a processor, the user data, further includes receiving, by the at least a processor, the user data as a function of an interaction between a user and a chatbot. This step may be implemented as described above with reference to FIGS. 1-8, without limitation.

With continued reference to FIG. 8, at step 810 method 800 includes generating, by the at least a processor, zone strategies based on the user data. In some embodiments, generating, by the at least a processor, the zone strategies based on the user data further includes classifying, by the at least a processor, the at least a user goal to a goal class, assigning, by the at least a processor, the at least a user goal to the goal class and generating, by the at least a processor the zone strategies as a function of the assigning the at least a user goal. In some cases, generating the zone strategies further includes selecting at least one individual zone strategy from a multiplicity of individual zone strategies assigned to the goal class. Additionally or alternatively, classifying, by the at least a processor, the at least a user goal, further includes, classifying, by the at least a processor, the at least a user goal using a classifier machine learning model. This step may be implemented as described above with reference to FIGS. 1-8, without limitation.

With continued reference to FIG. 8, at step 815 method 800 includes receiving, by the at least a processor, a plurality of zone strategy scores as a function of the zone strategies wherein at least one zone strategy score of the plurality of zone strategy scores is associated to at least one individual zone strategy of the zone strategies This step may be implemented as described above with reference to FIGS. 1-8, without limitation.

With continued reference to FIG. 8, at step 820 method 800 includes determining, by the at least a processor, follow through data as a function of the plurality of zone strategy scores and the zone strategies. In some cases, determining, by the at least a processor, follow through data as a function of the plurality of zone strategy scores and the zone strategies includes determining the follow through data using a follow through machine learning model. Additionally or alternatively, determining, by the at least a processor the follow through data using follow through machine learning model includes receiving, by the at least a processor, follow through training data comprising zone strategies and a plurality of zone strategy scores correlated to a plurality of follow through data, training, by the at least a processor, the follow through machine learning model as a function of the follow through training data and determining, by the at least a processor the follow through data as a function of the follow through machine learning model. In some cases, follow through data further includes improvement data, the improvement data containing data relating to the improvement of a user over a specific period of time. In some cases, follow through data includes at least one follow through plan, the at least one follow through plan correlated to the at least one individual zone strategy.

With continued reference to FIG. 8, at step 825 method 800 includes creating, by the at least a processor, a user interface data structure, wherein the user interface data structure comprises the zone strategies and the follow through data.

With continued reference to FIG. 8, at step 830 method 800 includes transmitting, by the at least a processor, the follow through data, the zone strategies, and the user interface data structure to a graphical user interface (GUI) communicatively connected to the at least a processor, the GUI configured to receive the user interface data structure and display the zone strategies and the follow through data as a function of the user interface data structure.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

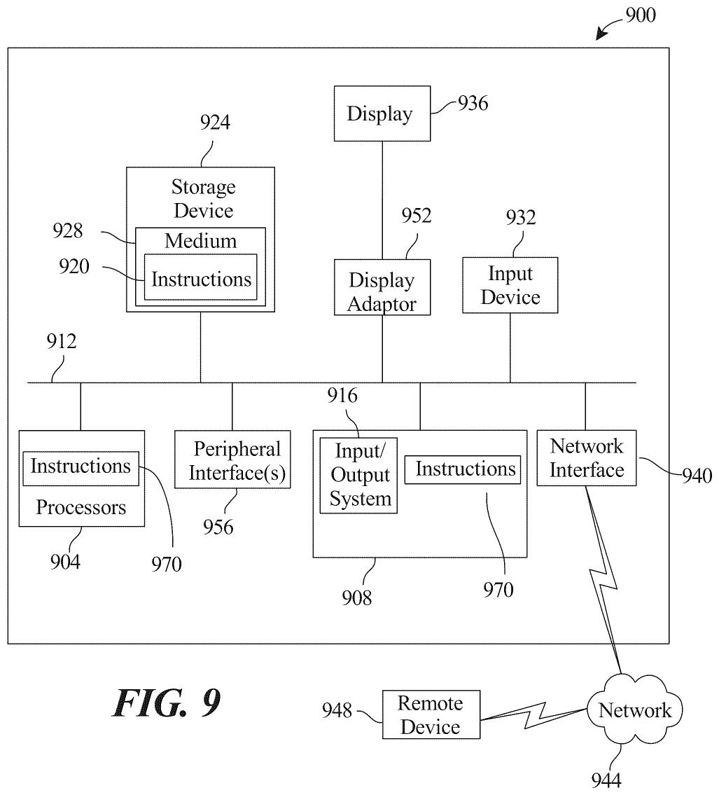

FIG. 9 shows a diagrammatic representation of one embodiment of a computing device in the exemplary form of a computer system 900 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 900 includes a processor 904 and a memory 908 that communicate with each other, and with other components, via a bus 912. Bus 912 may include any of several types of bus structures including, but not limited to, a memory bus, a memory controller, a peripheral bus, a local bus, and any combinations thereof, using any of a variety of bus architectures.

Processor 904 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 904 may be organized according to Von Neumann and/or Harvard architecture as a non-limiting example. Processor 904 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 908 may include various components (e.g., machine-readable media) including, but not limited to, a random-access memory component, a read only component, and any combinations thereof. In one example, a basic input/output system 916 (BIOS), including basic routines that help to transfer information between elements within computer system 900, such as during start-up, may be stored in memory 908. Memory 908 may also include (e.g., stored on one or more machine-readable media) instructions (e.g., software) 920 embodying any one or more of the aspects and/or methodologies of the present disclosure. In another example, memory 908 may further include any number of program modules including, but not limited to, an operating system, one or more application programs, other program modules, program data, and any combinations thereof.

Computer system 900 may also include a storage device 924. Examples of a storage device (e.g., storage device 924) include, but are not limited to, a hard disk drive, a magnetic disk drive, an optical disc drive in combination with an optical medium, a solid-state memory device, and any combinations thereof. Storage device 924 may be connected to bus 912 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 924 (or one or more components thereof) may be removably interfaced with computer system 900 (e.g., via an external port connector (not shown)). Particularly, storage device 924 and an associated machine-readable medium 928 may provide nonvolatile and/or volatile storage of machine-readable instructions, data structures, program modules, and/or other data for computer system 900. In one example, software 920 may reside, completely or partially, within machine-readable medium 928. In another example, software 920 may reside, completely or partially, within processor 904.

Computer system 900 may also include an input device 932. In one example, a user of computer system 900 may enter commands and/or other information into computer system 900 via input device 932. Examples of an input device 932 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 932 may be interfaced to bus 912 via any of a variety of interfaces (not shown) including, but not limited to, a serial interface, a parallel interface, a game port, a USB interface, a FIREWIRE interface, a direct interface to bus 912, and any combinations thereof. Input device 932 may include a touch screen interface that may be a part of or separate from display 936, discussed further below. Input device 932 may be utilized as a user selection device for selecting one or more graphical representations in a graphical interface as described above.

A user may also input commands and/or other information to computer system 900 via storage device 924 (e.g., a removable disk drive, a flash drive, etc.) and/or network interface device 940. A network interface device, such as network interface device 940, may be utilized for connecting computer system 900 to one or more of a variety of networks, such as network 944, and one or more remote devices 948 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 944, may employ a wired and/or a wireless mode of communication. In general, any network topology may be used. Information (e.g., data, software 920, etc.) may be communicated to and/or from computer system 900 via network interface device 940.

Computer system 900 may further include a video display adapter 952 for communicating a displayable image to a display device, such as display device 936. Examples of a display device include, but are not limited to, a liquid crystal display (LCD), a cathode ray tube (CRT), a plasma display, a light emitting diode (LED) display, and any combinations thereof. Display adapter 952 and display device 936 may be utilized in combination with processor 904 to provide graphical representations of aspects of the present disclosure. In addition to a display device, computer system 900 may include one or more other peripheral output devices including, but not limited to, an audio speaker, a printer, and any combinations thereof. Such peripheral output devices may be connected to bus 912 via a peripheral interface 956. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, apparatuses, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for zone strategy selection, the apparatus comprising:
a wearable device;
at least a processor;
a memory communicatively connected to the processor, the memory containing instructions configuring the processor to:
receive, by the wearable device, a plurality of physiological data;
determine a user confidence level as a function of the plurality of physiological data;
receive user data, wherein the user data comprises at least a user goal, wherein the at least a user goal comprises at least an improvement in the user confidence level;
pre-process user data, wherein processing user data comprises converting the user data into text-based data using an automatic speech recognition device, wherein the automatic speech recognition device is connected to a network, wherein the automatic speech recognition device is configured to transmit the user data to the network for processing;
classify the pre-processed user data to a confidence class using a confidence classifier configured to correlate components of user data to one or more confidence groupings;
generate zone strategies based on the pre-processed user data, wherein the zone strategies are configured to increase the user confidence level, wherein generating zone strategies further comprises:
iteratively training a zone strategy machine learning model using zone strategy training data applied to an input layer of nodes, wherein the input layer of nodes comprises a plurality of user data, one or more intermediate layers, and an output layer of nodes, wherein the output layer of nodes comprises a plurality of zone strategies;
adjusting the one or more connections and one or more weights between nodes in adjacent layers of the zone strategy machine learning model to iteratively update the output layer of nodes by updating the zone strategy training data applied to the input layer of nodes; and
retraining the zone strategy machine learning model with an updated zone strategy training data, wherein the zone strategy machine learning model is further retrained as a function of feedback provided by a user;
receive a plurality of zone strategy scores as a function of the zone strategies and the zone strategy machine learning model, wherein at least one zone strategy score of the plurality of zone strategy scores is associated to at least one individual zone strategy of the zone strategies that is grouped within the confidence class;
determine follow through data as a function of the plurality of zone strategy scores and the zone strategies;
generate a user interface data structure, wherein the user interface data structure comprises the zone strategies and the follow through data;
transmit the user interface data structure;
a graphical user interface (GUI) communicatively connected to the at least a processor, wherein the GUI comprises an interaction component comprising a plurality of components configured to allow the user to input a plurality of strategy scores and provide user feedback, wherein the GUI is configured to:
receive the user interface data structure; and
display the zone strategies and the follow through data as a function of the user interface data structure;
provide feedback from the user on the zone strategies to the zone strategy machine learning model for retraining.

2. The apparatus of claim 1, wherein the user data further comprises assessment data wherein assessment data comprises physiological traits of the user.

3. The apparatus of claim 1, wherein the memory contains instructions further configuring the at least a processor to retrieve the user data from a database, wherein the user data further comprises current data and a plurality of previously entered user data.

4. The apparatus of claim 1, wherein the processor is further configured to receive the user data as a function of an interaction between a user and a chatbot.

5. The apparatus of claim 1, wherein generating the zone strategies based on the user data comprises:
classifying the at least a user goal to a goal class;
assigning the at least a user goal to the goal class; and
generating the zone strategies as a function of the assigning the at least a user goal to a goal class, wherein generating the zone strategies comprises selecting at least one individual zone strategy from a multiplicity of individual zone strategies assigned to the goal class.

6. The apparatus of claim 5, wherein classifying the at least a user goal further comprises classifying using a classifier machine learning model.

7. (canceled)

8. (canceled)

9. The apparatus of claim 3 wherein the follow through data further comprises improvement data, the improvement data containing data relating to the improvement of a user over a specific period of time.

10. The apparatus of claim 1, wherein the follow through data comprises at least one follow through plan, wherein the at least one follow through plan is correlated to the at least one individual zone strategy.

11. A method for zone strategy selection, the method comprising:
receiving, by a wearable device, a plurality of physiological data;
determining, by at least a processor, a user confidence level as a function of the plurality of physiological data;
receiving, by the at least a processor, user data, wherein the user data comprises at least a user goal wherein the at least a user goal comprises at least an improvement in the user confidence level;
classify user data to a confidence class using a confidence classifier configured to correlate components of user data to one or more confidence groupings;
generating, by the at least a processor, zone strategies based on the user data, wherein the zone strategies are configured to increase the user confidence level, wherein generating zone strategies further comprises:
iteratively training a zone strategy machine learning model using zone strategy training data applied to an input layer of nodes, wherein the input layer of nodes comprises a plurality of user data, one or more intermediate layers, and an output layer of nodes, wherein the output layer of nodes comprises a plurality of zone strategies;
adjusting one or more connections and one or more weights between nodes in adjacent layers of the zone strategy machine learning model to iteratively update the output layer of nodes by updating the zone strategy training data applied to the input layer of nodes; and
retraining the zone strategy machine learning model with an updated zone strategy training data wherein the zone strategy machine learning model is further retrained as a function of feedback provided by a user;
receiving, by the at least a processor, a plurality of zone strategy scores as a function of the zone strategies and the zone strategy machine learning model, wherein at least one zone strategy score of the plurality of zone strategy scores is associated to at least one individual zone strategy of the zone strategies that is grouped within the confidence class;
determining, by the at least a processor, follow through data as a function of the plurality of zone strategy scores and the zone strategies;
generating, by the at least a processor, a user interface data structure, wherein the user interface data structure comprises the zone strategies and the follow through data; and
transmitting, by the at least a processor, the user interface data structure to a graphical user interface (GUI) communicatively connected to the at least a processor, wherein the GUI comprises an interaction component comprising a plurality of components configured to allow the user to input a plurality of strategy scores and provide user feedback, wherein the GUI is configured to:
receive the user interface data structure; and
display the zone strategies and the follow through data as a function of the user interface data structure;
provide feedback from the user on the zone strategies to the zone strategy machine learning model for retraining.

12. The method of claim 11, wherein the user data further comprises assessment data wherein assessment data comprises physiological traits of the user.

13. The method of claim 11, wherein receiving, by the at least a processor, the user data, further comprises, receiving by the at least a processor, the user data from a database, wherein the user data comprises current data and a plurality of previously entered user data, the plurality of previously entered user data.

14. The method of claim 11, wherein receiving, by the at least a processor, the user data further comprises receiving, by the at least a processor, the user data as a function of an interaction between a user and a chatbot.

15. The method of claim 11, wherein generating, by the at least a processor, the zone strategies based on the user data further comprises:
classifying, by the at least a processor, the at least a user goal to a goal class;
assigning, by the at least a processor, the at least a user goal to the goal class; and
generating, by the at least a processor the zone strategies as a function of the assigning the at least a user goal comprising selecting at least one individual zone strategy from a multiplicity of individual zone strategies assigned to the goal class.

16. The method of claim 15, wherein classifying, by the at least a processor, the at least a user goal further comprises classifying, by the at least a processor, using a classifier machine learning model.

17. (canceled)

18. (canceled)

19. The method of claim 13, wherein the follow through data further comprises improvement data, the improvement data containing data relating to the improvement of a user over a specific period of time.

20. The method of claim 11, wherein the follow through data comprises at least one follow through plan, wherein the at least one follow through plan is correlated to the at least one individual zone strategy.
